(19) United States
(12) Patent Application Publication
(10) Pub. No.: US 2008/0094689 A1
(43) Pub. Date: Apr. 24, 2008

(54) Bright Full Color Reflective Display

(75) Inventors: Ramon P. Van Gorkom, Eindhoven (NL); Siebe T. De Zwart, Valkenswaard (NL); Volker Schollmann, Dusseldorf (DE); Ruediger J. Lange, Waalre (NL); Yvonne W. Kruijt-Stegeman, Eindhoven (NL); Rogier Winters, Weert (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/718,765

(22) PCT Filed: Nov. 9, 2005
(86) PCT No.: PCT/IB05/53693

§ 371 Date: May 7, 2007

Related U.S. Application Data
(60) Provisional application No. 60/627,696, filed on Nov. 12, 2004.

(51) Int. Cl. G02F 1/167; G02F 1/23; G02F 1/13

(52) U.S. Cl. 359/296; 359/290; 349/1

(57) ABSTRACT

A full color high brightness reflective display (200, 250, 300, 350) is formed from individual multifaced pyramid-like reflectors (400, 450, 500, 600, 725, 800). Each face (410, 420, 460, 470 510, 520, 610, 620, 730, 740, 810, 820) of the reflector specularly reflects two of the three primary colors of incident light (461, 481, 581, 661, 781, 861), and can be controlled to either reflect, diffusely or specularly, or absorb the other primary color, thereby controlling a color of reflected light (462, 482, 582, 662, 782, 862). A liquid crystal layer (415, 425, 465, 475) may be used at each face, with a polarization filter (480) at the entrance to the reflector, or combined with the layer. An electro wetting cell (514, 524) or an electrophoretic layer (615, 625) may also be used. A deposition layer formed by reversible metal deposition may be used. A movable, dynamic foil mechanism (850) may also be used. The display may be made up of multiple reflectors (210, 220, 260, 270, 310, 320, 360, 370) arranged in a repeating pattern.

The invention relates generally to a reflective display, and more particularly to a reflective display that is based on the optical properties of retro-reflectors.

For outdoor applications, reflective displays are usually best because it is difficult to get sufficient brightness and contrast from an emissive display. The most well known reflective display is the liquid crystal display (LCD). However, a disadvantage with such displays is that a polarizer is used, which throws away 50% of the light. To make a color reflective display, a color filter is added for each of the sub-pixels. This means that even if all the sub-pixels are in the “on” state, an additional 66% of the light is thrown away, since e.g., red and blue are absorbed at the green sub-pixel (two of the three primary colors), totaling up to a 85-90% loss. A brighter reflective display is E-ink (available from E-Ink Corp., Cambridge, Mass.), which is mainly being studied for e-book solutions. However, if a color filter is added to an E-ink display the brightness is also highly reduced, leaving approximately only 30% of the light. Furthermore, E-ink is relatively slow (with a switching time of about 400 ms) and it is difficult to achieve a sufficient number of grey scales. An alternative that aims to improve this situation is the electro wetting display, which uses two layers of colored oils to subtract the colors, together with a color filter. This improves the situation but still cannot reach 100% brightness, due to the color filter. Other approaches use incident light of different colors but this increases complexity.

The present invention addresses the above and other issues.

In contrast to some prior approaches, where light either reflects by total internal reflection (TIR) or gets absorbed, some embodiments of the present invention do not rely on TIR at all, even in the white state, where no light is absorbed. Instead of using TIR, the present invention can use different kinds of reflection, e.g. metallic, from a multilayer or even diffuse reflections. The various embodiments of the present invention can provide reflection of specific colors only.

In one aspect of the invention, a reflector for reflecting incident light having at least first and second primary colors includes at least first, second and third planar faces joined together pyramidally. The first face specularly reflects at least the second primary color while being controllable to either reflect or absorb the first primary color, and the second face specularly reflects at least the first primary color while being controllable to either reflect or absorb the second primary color. For example, a spectrum having three primary colors can be split up into two colors.

Or, the reflector could reflect incident light having first, second and third primary colors, where the first face specularly reflects the second and third primary colors while being controllable to either reflect or absorb the first primary color, the second face specularly reflects the first and third primary colors while being controllable to either reflect or absorb the second primary color, and the third face specularly reflects the first and second primary colors while being controllable to either reflect or absorb the third primary color.

The primary colors can include red, green and/or blue, but are not limited to these.

Furthermore, at least one of the faces may use an electrophoretic layer. For example, in one approach, at least the first face includes a reflective color filter and an electrophoretic layer behind the reflective color filter. In another approach, at least the first face includes an electrophoretic layer, and the electrophoretic layer includes absorptive colored particles that move laterally to switch between reflecting and absorbing the first primary color.

In another aspect of the invention, a reflector includes a ridge shaped structure having two faces for reflecting incident light as reflected light. At least one of the faces has a reflective polarization layer, a liquid crystal layer behind the reflective polarization layer, and a reflector layer behind the liquid crystal layer.

In the drawings:

In all the Figures, corresponding parts are referenced by the same reference numerals.

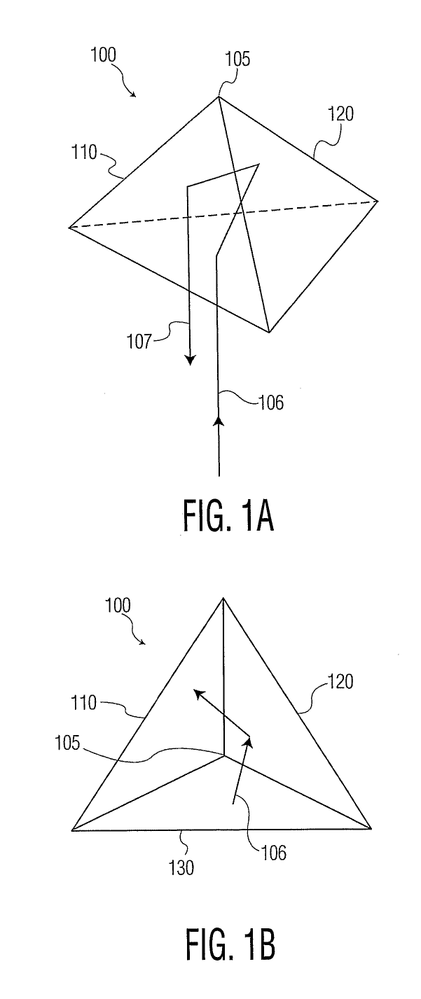

FIG. 1a illustrates a schematic perspective view of a pyramid shaped reflector;

FIG. 1b illustrates a bottom view of the pyramid shaped reflector of FIG. 1a;

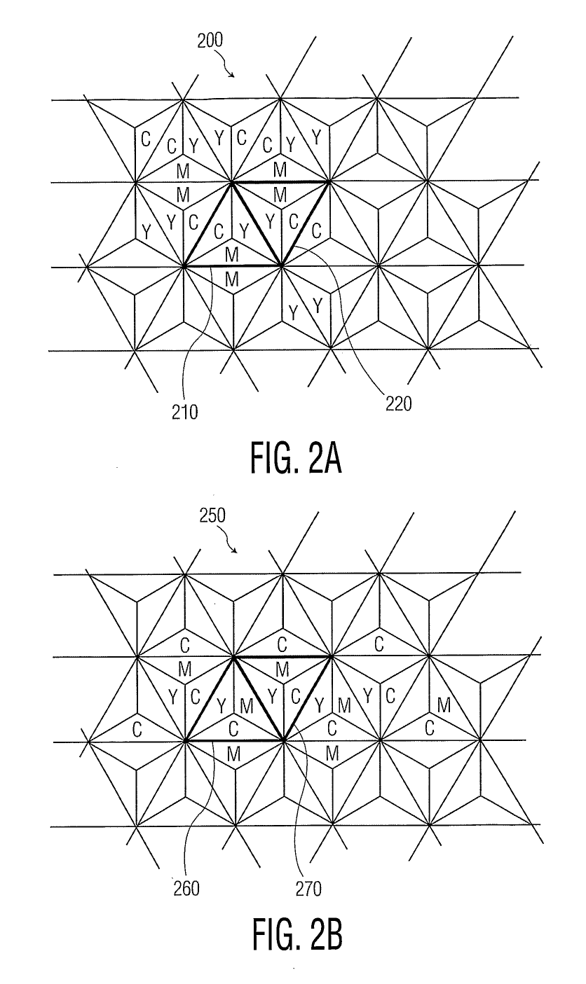

FIG. 2a illustrates a schematic top view of a display made from an arrangement of several individual pyramid shaped reflectors, where two adjacent reflector sides are the same color, according to one embodiment of the invention;

FIG. 2b illustrates a schematic top view of a display made from an arrangement of several individual pyramid shaped reflectors, where two adjacent reflector sides are not the same color, according to one embodiment of the invention;

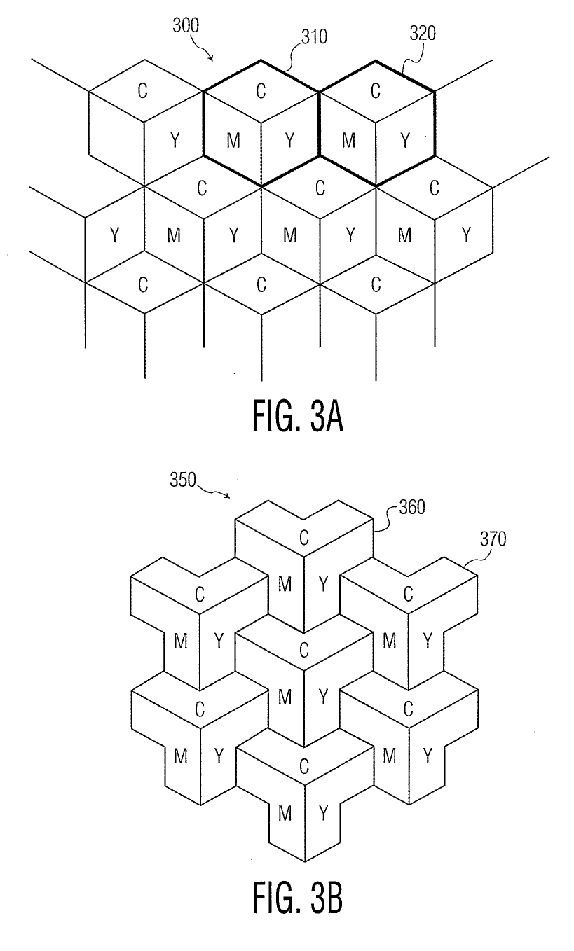

FIG. 3a illustrates a schematic top view of a first display made from an arrangement of several individual pyramid shaped reflectors, where sides having the same color face in the same direction, according to one embodiment of the invention;

FIG. 3b illustrates a schematic top view of a second display made from an arrangement of several individual pyramid shaped reflectors, where sides having the same color face in the same direction, according to one embodiment of the invention;

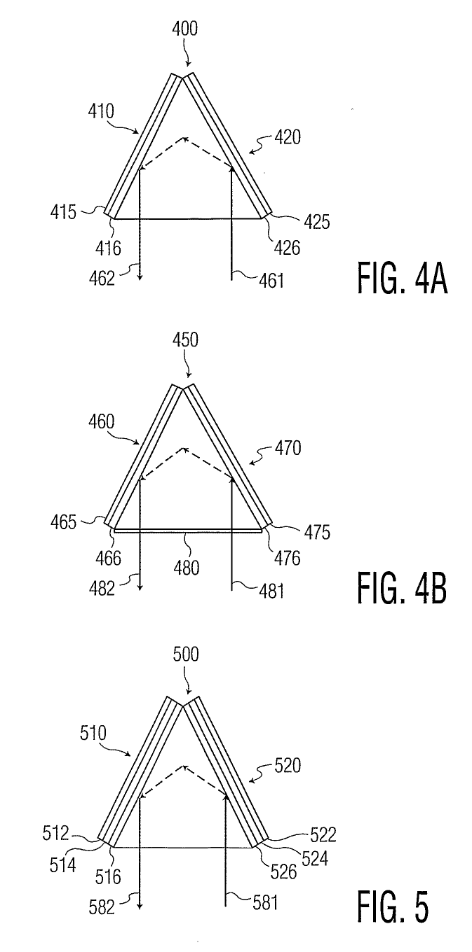

FIG. 4a illustrates a schematic cross-sectional view of a single reflector with an LCD cell and a polarization filter in the LCD cell, according to one embodiment of the invention;

FIG. 4b illustrates a schematic cross-sectional view of a single reflector with a separate LCD cell and a polarization filter, according to one embodiment of the invention;

FIG. 5 illustrates a schematic cross-sectional view of a single reflector with electro wetting liquid, according to one embodiment of the invention;

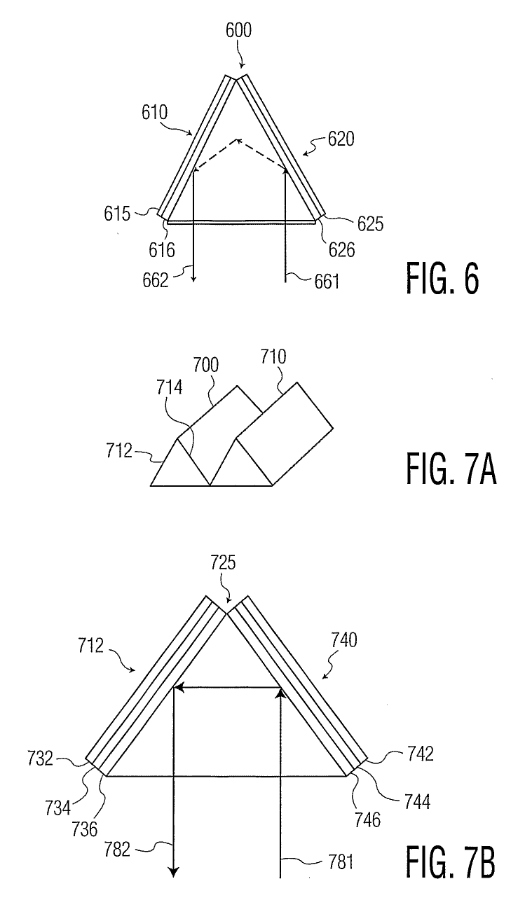

FIG. 6 illustrates a schematic cross-sectional view of a single reflector with an electrophoretic layer, according to one embodiment of the invention;

FIG. 7a illustrates a schematic perspective view of a ridge-shaped reflector, according to one embodiment of the invention;

FIG. 7b illustrates a schematic view of a ridge shaped reflector with reflecting polarization filters, according to one embodiment of the invention; and

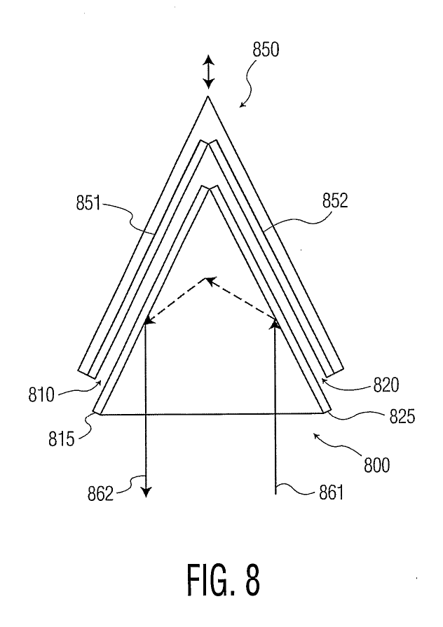

FIG. 8 illustrates a schematic cross-sectional view of a dynamic foil display, according to one embodiment of the invention.

### INTRODUCTION

The present invention proposes a new type of reflective display that is based on the optical properties of retro-reflectors and structures derived from them. A retro reflector can be formed, e.g., as a three-sided pyramid where the three faces are perpendicular with respect to each other. Light that is reflected from the structure hits all three faces of the pyramid. We can selectively absorb each of the primary colors at one of the three faces of the pyramid. This makes it possible to make a high brightness full color display, e.g., in the white state, it can be 100% white, and in the black state, it can be completely black. The present invention provides different ways to absorb and reflect the three primary colors.

Making a Reflective Display Using Retro-Reflectors

Retro-reflectors approximately reflect incoming light back to the source. A retro-reflector may consist of at least three planar sides joined together pyramidally, e.g., to form at least part of a pyramid. Each side has a respective face for reflecting light. For example, the retro-reflector may be made up of a three triangular pyramid, i.e., a corner part of a cube, as shown in FIGS. 1a and 1b. The three faces of the pyramid are perpendicular to each other. FIG. 1a shows a 3D view of a retro reflector 100 and a path of an example incident light beam 106, which is reflected by the reflector 100 as reflected light 107. Two sides 110, 120 of the three sides are shown. The sides are joined to one another and meet at a common vertex 105. Note that the retro-reflector need not be precisely a pyramid but may be formed by part of a pyramid. For example, the structure 100 may be modified by cutting off the top portion. FIG. 1b shows a bottom view of the retro-reflector 100, including all three sides 110, 120 and 130. It can be seen that the light beam 106 hits all three sides of the pyramid before exiting. This property makes it possible to use each of the three sides 110, 120 and 130 to selectively absorb one of the three primary colors, e.g., red, green and blue. That is, it is possible to selectively absorb all the light, or reflect all light, or reflect a certain color light (not limited to only the three primary colors, e.g., by absorbing different portions of the primary colors, mixed colors can also be made).

FIGS. 2a and 2b show two possible arrangements for triangular reflectors. Below, we will show other possibilities. FIG. 2a shows a version where two adjacent sides have the same color. This can be advantageous for manufacturing reasons, e.g., we can put the same information on both the sides. In particular, the display 200 includes several individual reflectors arranged in rows and columns, adjacent to one another, such as example reflectors 210 and 220. The reflectors include three faces. In one possible approach, one face always reflects magenta (M), one always reflects yellow (Y), and one always reflects cyan (C). As can be seen, the yellow (Y) faces of the reflector 210 and 220 are adjacent to one another. Generally one face absorbs, specularly reflects or diffusely reflects, one of the primary colors. The other two colors should be specularly reflected, such as by using a reflective color filter. This reflection therefore need not occur by total internal reflection.

By using this arrangement when no colors are absorbed, a full white remains. When each side absorbs its primary color, then no light is reflected. An appropriate control mechanism can be employed to control each reflector individually to create a desired pattern on the display 200 or 250.

FIG. 2b shows an arrangement where the colors are further apart, which gives an enhanced resolution. That is, a face with a given color in one reflector is not adjacent to a face with the same color in an adjacent reflector. In particular, the display 250 includes several individual reflectors arranged in rows and columns, adjacent to one another, such as example reflectors 260 and 270. As with the display 200 of FIG. 2a, the reflectors each include three faces. One face either reflects magenta (M) or white, one reflects yellow (Y) or white, and one reflects cyan (C) or white. As can be seen, the magenta (M) face of the reflector 260 is adjacent to the yellow (Y) face of the reflector 270. FIGS. 3a and 3b show two further possibilities for making reflectors. FIG. 3a illustrates a schematic top view of a first display 300 made from an arrangement of several individual pyramid shaped reflectors, where sides having the same color face in the same direction, according to the invention. In particular, the display 300 includes several individual reflectors, such as example reflectors 310 and 320, which are arranged adjacent to one another. FIG. 3b illustrates a schematic top view of a second display 350 made from an arrangement of several individual pyramid shaped reflectors, where sides having the same color face in the same direction, according to the invention. In particular, the display 350 includes several individual reflectors, such as example reflectors 360 and 370, which are arranged adjacent to one another.

These reflectors have the advantage that all surfaces with one color are perpendicular to all the other surfaces with another color. In other words, surfaces that reflect or absorb the same color face in the same direction. This makes it possible to selectively coat one of the three surfaces by using evaporation where the incoming flux has one particular direction. This can even be done for the three surfaces simultaneously.

Each pixel in a display can be made up of any number of individual reflector elements, i.e., one or more elements. Thus, we can make the reflectors smaller than the pixel size. Furthermore, we can make grayscales by partly covering a reflector, such that not all the light is absorbed, but only a portion is absorbed. We can do this with a sort of roll-blind, e.g., by covering the reflector partly from either the base or the top, or we can provide a more random covering of the surface.

A possible variant is to have the three faces of the reflector not perpendicular to each other but slightly off perpendicular. This can make it easier to collect light from different angles.

Below, we show different ways to make sides of the reflector switch between absorbing and reflecting. Some approaches will make use of total internal reflecting, while others make use of direct reflection (from metal layers or multilayers). Finally, some will make use of diffuse reflections. If the refractive index of the material used is too low, then the former might suffer from some viewing angle dependence issues.

Note that an appropriate control mechanism including drive electronics can be used to control the displays 200 and 250. For example, row and column lines can be connected to electrodes which control the switching of the faces of the individual reflectors between reflecting and absorbing states.

LCD

FIG. 4a illustrates a schematic cross-sectional view of a single reflector with an LCD cell and a polarization filter in the LCD cell, according to the invention. Two sides 410, 420 of the three sides are shown. Incident light 461 is reflected as reflected light 462. FIG. 4b illustrates a schematic cross-sectional view of a single reflector with a separate LCD cell and a polarization filter, according to the invention. Two sides 460, 470 of the three sides are shown. Here, incident light 481 is reflected as reflected light 482. The reflectors 400 and 450 show only reflection at two sides, but in reality this will happen at all three sides. The reflector 400 includes sides 410 and 420 with respective color filters 416 and 426, and LCD cells or layers 415 and 425 combined with polarization filters. The reflector 450 includes sides 460 and 470 with respective color filters 466 and 476, LCD cells or layers 465 and 475, e.g., in a layer stack and a polarization filter 480 provided at the entrance to the reflector 450.

The most straightforward way to employ an LCD is to use a liquid crystal (LC) layer at each face of the reflector. The LC layer together with the polarization layer and reflector will either absorb or reflect the incident light. The reflection can be by means of total internal reflection or by adding a metallic or multilayer reflector, for instance. The three sides of the pyramid should be covered with a reflective color filter in order to let only one of the three primary colors through. A disadvantage of the embodiment of FIG. 4b is that we must add a polarization filter 480, which throws away 50% of the light. This can be added at the entrance of the retro reflector (FIG. 4b) or it can be combined with LC layers 415 and 425 (FIG. 4a). However, using this approach to make a reflective color display is still much better than adding a color filter to an E-ink display, because it is much brighter and can be switched much faster.

Techniques such as in plane switching (IPS), vertical alignment (VA), twisted nematic (TN), and the like, can be used by adding appropriate “state of the art” electrode structures.

Electro Wetting

FIG. 5 illustrates a schematic cross-sectional view of a single reflector with electro wetting liquid, according to the invention. Two sides 510, 520 of the three sides are shown. In this approach an electro wetting cell is added to each side of the reflector. We can then use, for example, a yellow, Cyan and magenta ink together with normal transparent water, backed by a reflector. In this way, the light will either go through the colored inks or just be reflected. This option does not rely on total internal reflection. There are in fact two options. One option uses colored inks. The other option uses a black ink. The latter requires reflective color filters to be added, while the former does not. For instance, for the reflector 500, one face 510 can include a reflector 512, an electro wetting liquid 514, and a reflective color filter 516. Another face 520 can include a reflector 522, an electro wetting liquid 524, and a reflective color filter 526. Incident light 581 is reflected as reflected light 582.

Another way is similar to electro wetting, which is reversible metal deposition from a solution, e.g., silver from silver nitrate (See K. Shinozaki, “Electrodeposition Device for Paper-Like Displays,” SID 02 digest paper 5.5L, 2002, incorporated herein by reference). This process is similar to what happens in a car battery. If this metal deposition is used then reflective color filters should be present on the three faces of the retro reflector.

Electrophoretic Layer

FIG. 6 illustrates a schematic cross-sectional view of a single reflector with an electrophoretic layer. Two sides 610, 620 of the three sides are shown. A further approach is to use an electrophoretic layer (e.g., E-ink) with black absorbing and white scattering particles. Generally, there are two ways electrophoretic layers can switch—either laterally or perpendicularly. The latter requires two types of particles, i.e., scattering and absorbing particles, but tends to provide a better appearance. The former only requires one type of particle, i.e., absorbing particles, because when the particles move to the side they can expose a reflector.

The example reflector 600 includes faces 610 and 620 which reflect incident light 661 to provide reflected light 662. With perpendicular switching, we can, for example, use a reflective color filter 616, 626 on each face of the reflector, and an electrophoretic layer 615, 625 below the reflective color filter for switching between diffusively reflecting and absorbing a different primary color of incident light. For example, the green light which hits the red and blue sides should get specularly reflected and will reach the green side, but the green light itself can be diffusely scattered at the green side. The blue and red light should be specularly reflected at the green side, etc. This type of reflector is not a true retro-reflector because the light gets diffusely scattered once it reaches the correct sub-pixel or reflector.

An in plane, lateral switching electrophoretic layer uses just absorbing particles which move laterally through the layer to perform the switching between absorbing and (with the help of a reflector or by TIR) reflecting. In this case a mirror can be placed behind the electrophoretic layer to reflect the light. Two options exist. Colored particles can be used, in which case no reflective color filters are needed, or black particles can be used, in which case reflective color filters are needed in order to only absorb one of the primary colors at each side. This approach is analogous to the electro wetting embodiment discussed above.

Alternative Black and White Reflective Displays

We can use a somewhat related structure to make an alternative to the standard E-ink display, which is black and white and highly reflective by using not retro-reflectors but ridge shaped structures, as shown in FIGS. 7a and 7b. FIG. 7a illustrates a structure with example ridges 710 and 720. Ridge 710 has faces 712 and 714. FIG. 7b illustrates a reflector 725 built from one of the example ridges. Incident light 781 is reflected as reflected light 782. The face 730 includes a reflector 732, an LCD cell 734, and a reflective polarization filter 736 rotated 90 degrees. The face 740 includes a reflector 742, an LCD cell 744, and a reflective polarization filter 746 rotated 90 degrees. In particular, the faces 730 and 740 may be coated with a reflective polarization filter, and below the filter we can use an LCD to switch one of the two polarization directions. Thus, on each side or face of the ridges LCDs with reflective polarization filters can be placed. In this way, we do not lose the 50% of the light in the polarization filter and hence a bright reflective LCD display can be achieved.

However, we can also use any of the other preceding technologies (Electro wetting, electro deposition, DFD) to make a bright display as a black and white display.

Dynamic Foil Display

FIG. 8 illustrates a dynamic foil display. Two sides 810, 820 of the three sides are shown. A further approach is to use a dynamic foil display reflector 800 in which a moving mechanism 850 behind the reflector 800 switches the reflector 800 from total internal reflection to an absorbing state. Incident light 861 contacts the reflector 800 and is reflected as reflected light 862. We can either use a colored foil 815, 825 or use reflective color filters on each side 810, 820 of the reflector 800 in combination with an absorbing foil 851, 852, such as a black foil. If the foil 851, 852 in the mechanism 850 is in contact with the reflector 800, or selected faces of the reflector, the total internal reflection of the incident light 861 is broken and one of the three primary colors is absorbed. If the foil in the mechanism 850 is away from the reflector 800, then the reflector works as a normal retro reflector. An appropriate control scheme can be used for moving the mechanism 850 with the foil relative to the reflector 800, or vice versa. In particular, adding the reflective color filters to the sides 810, 820 of the reflector 800 causes the other colors (the colors other than the color of the filter) to be specularly reflected. The light that comes through either reflects due to total internal reflection or gets absorbed, e.g., with a black foil. Another option is to use a color foil whereby, depending on the state of the reflector, all of the light gets totally internally reflected or one of the components gets absorbed.

Control Mechanisms

In any of the embodiments disclosed herein, those of ordinary skill in the art will appreciate that an appropriate control mechanism including drive electronics can be used to control the reflector elements in a display. The layers on the faces of the reflector can be switched on and off to provide the desired absorption or transmission, if grey levels are not needed. If grey levels are needed then the drive electronics must be adapted accordingly. Appropriate driving must be provided for the electrophoretic embodiments as well. Any state of the art driving scheme can be used. For example an active matrix can be added to control the pixels or the pixels can be addressed passively. The different electrode configurations which are need to switch the different reflector embodiments disclosed herein should be apparent to those skilled in the art.

### CONCLUSION

We have shown ways to make a full color high brightness reflective display that can be a very attractive option for different application areas. Absorption and reflection of light can be controlled at two or more of the faces of a three-sided reflector. When only two faces are controllable, a spectrum having three primary colors can be split up into two colors. At one of the three sides, the first color is reflected and the second color is reflected or absorbed. At another side, the second color is reflected and the first color is reflected or absorbed. The third side reflects both the first and second colors.

While there has been shown and described what are considered to be preferred embodiments of the invention, it will, of course, be understood that various modifications and changes in form or detail could readily be made without departing from the spirit of the invention. It is therefore intended that the invention not be limited to the exact forms described and illustrated, but should be construed to cover all modifications that may fall within the scope of the appended claims.

1. A reflector for reflecting incident light having at least first and second primary colors, comprising:
at least first, second and third planar faces (410, 420, 460, 470 510, 520, 610, 620, 730, 740, 810, 820) joined together pyramidally; wherein:
the first face specularly reflects at least the second primary color while being controllable to either reflect or absorb the first primary color; and
the second face specularly reflects at least the first primary color while being controllable to either reflect or absorb the second primary color.

2. The reflector of claim 1, wherein:
the third face specularly reflects the first and second primary colors.

3. The reflector of claim 1, wherein:
the specular reflection used by the first and second faces comprises metallic reflection, multilayer reflection or total internal reflection.

4. The reflector of claim 1, wherein:
the first face is controllable to specularly or diffusely reflect the first primary color or absorb the first primary color; and
the second face is controllable to specularly or diffusely reflect the second primary color or absorb the second primary color.

5. The reflector of claim 1, wherein:
the incident light (461, 481, 581, 661, 781, 861) also has a third primary color;
the first face specularly reflects the second and third primary colors;
the second face specularly reflects the first and third primary colors; and
the third face specularly reflects the first and second primary colors while being controllable to either reflect or absorb the third primary color.

6. The reflector of claim 5, wherein:
the first, second and third primary colors are red, green and blue, respectively.

7. The reflector of claim 1, wherein:
at least the first face comprises a layer stack including a liquid crystal layer (415, 425, 465, 475) and a polarization layer (736, 746); and
the liquid crystal layer is switchable to either reflect or absorb the first primary color.

8. The reflector of claim 7, wherein:
the layer stack further includes a reflective color filter (416, 426) before the liquid crystal layer; and
the liquid crystal layer always specularly reflects the second primary color.

9. The reflector of claim 7, wherein:
the polarization layer is combined with the liquid crystal layer.

10. The reflector of claim 1, further comprising:
a polarization filter (480) located at an entrance to the reflector; wherein:
at least the first face comprises a liquid crystal layer (415, 425, 465, 475); and
the liquid crystal layer is switchable to either reflect or absorb the first primary color.

11. The reflector of claim 1, wherein:
at least the first face comprises an electro wetting cell (514, 524);
the electro wetting cell includes oil having a color that absorbs the first primary color; and
the electro wetting cell is controllable to either reflect or absorb the first primary color.

12. The reflector of claim 1, wherein:
at least the first face comprises an electro wetting cell (514, 524) and a reflective color filter (516, 526);
the electro wetting cell includes a black oil that absorbs the first primary color; and
the electro wetting cell is controllable to either reflect or absorb the first primary color.

13. The reflector of claim 1, wherein:
at least the first face comprises a deposition layer and a reflective color filter; and
the deposition layer is formed by reversible metal deposition, and is controllable to either reflect or absorb the first primary color.

14. The reflector of claim 1, further comprising:
a dynamic foil mechanism (850) that is movable relative to at least the first face (810, 820) between first and second positions to cause the at least the first face to either reflect or absorb the first primary color.

15. The reflector of claim 14, wherein:
the at least the first face comprises a reflective color filter (815, 825) and the dynamic foil mechanism comprises an absorbing foil (851, 852).

16. A display (200) comprising a plurality of the reflectors of claim 1, wherein:
the plurality of the reflectors are arranged in a repeating pattern in which adjacent faces of neighboring ones of the reflectors can selectively absorb the same primary color.

17. A display (250) comprising a plurality of the reflectors of claim 1, wherein:
the plurality of the reflectors are arranged in a repeating pattern in which adjacent faces of neighboring ones of the reflectors can selectively absorb a different primary color.

18. A display (300, 350) comprising a plurality of the reflectors of claim 1, wherein:
the plurality of the reflectors are arranged in a repeating pattern in which faces of the reflectors that can selectively absorb the same primary color are oriented in the same direction.

19. The reflector of claim 1, wherein:
at least the first face comprises a reflective color filter (616, 626) and an electrophoretic layer (615, 625) behind the reflective color filter; and
the electrophoretic layer includes scattering and absorbing particles.

20. The reflector of claim 1, wherein:
at least the first face comprises an electrophoretic layer and a reflective color filter behind the electrophoretic layer; and
the electrophoretic layer includes absorbing particles.

21. The reflector of claim 1, wherein:
at least the first face comprises an electrophoretic layer (615, 625) including colored particles that move laterally to switch between reflecting and absorbing the first primary color.

22. A reflector for an electrophoretic display, comprising:
a ridge shaped structure (725) having two faces (730, 740) for reflecting incident light (781) as reflected light (782);
wherein at least one of the faces has a reflective polarization layer (736, 746), a liquid crystal layer (734, 744) behind the reflective polarization layer, and a reflector layer (732, 742) behind the liquid crystal layer.

23. The reflector of claim 22, wherein:
the liquid crystal layer is controllable to control the color of the reflected light.
